(19) United States
(12) Patent Application Publication
(10) Pub. No.: US 2025/0245381 A1
(43) Pub. Date: Jul. 31, 2025

(54) IDENTITY VERIFICATION WITH PRIVACY PRESERVATION

(71) Applicant: Zvezdin BESARABOV, London (GB)

(72) Inventor: Zvezdin BESARABOV, London (GB)

(21) Appl. No.: 19/040,800

(22) Filed: Jan. 29, 2025

Related U.S. Application Data
(60) Provisional application No. 63/626,473, filed on Jan. 29, 2024.

(51) Int. Cl. G06F 21/62

(52) U.S. Cl. CPC G06F 21/6245

(57) ABSTRACT

The techniques herein are directed generally to application of “zero-knowledge” techniques that allow for proof of information in manner in which the information itself is not revealed. As will be appreciated, a zero-knowledge (ZK) proof or zero-knowledge protocol is a method by which one party (the prover) can prove to another party (the verifier) that a given statement is true, while avoiding conveying to the verifier any information beyond the mere fact of the statement's truth.

### RELATED APPLICATION

This application claims priority to U.S. Provisional Application No. 63/626,473, filed Jan. 29, 2024, entitled IDENTITY VERIFICATION WITH PRIVACY PRESERVATION, by Zvezdin BESARABOV, the contents of which are incorporated herein by reference.

### TECHNICAL FIELD

The present disclosure relates generally to verification of information without data disclosure, and, more particularly, to identity verification with privacy preservation.

### BACKGROUND

There are many situations in which a person may be required to provide identification to, for example, prove their identity, age, or other information that is commonly found on an identification document. Identification documents can include government-issued identification documents that are issued by a government agency with sufficient authority and importance to be universally recognized. Some common examples of government-issued identification documents can include a driver's license, passport, military ID, etc. and these identification documents generally include various identification information such as a photograph, a full name, a date of birth, a place of birth, an issuance date and agency that issued the document, and/or fingerprints or other biometric information.

Generally, in order for a person to prove their identity, age, or other identifying information, the person would be required to provide the physical government-issued identification document.

### SUMMARY

The techniques herein are directed generally to application of “zero-knowledge” techniques that allow for proof of information in manner in which the information itself is not revealed. As will be appreciated, a zero-knowledge (ZK) proof or zero-knowledge protocol is a method by which one party (the prover) can prove to another party (the verifier) that a given statement is true, while avoiding conveying to the verifier any information beyond the mere fact of the statement's truth. In general, the prover and the verifier may each have access to a same ZK circuit that represents a computation and/or statement to be proven. This computation may have an output (e.g., a public output) that is based on multiple inputs (e.g., private inputs). The proof (e.g., a ZK proof) is a proof that the statement is had a corresponding output associated therewith that indicates the same. Because the only public information generated by the ZK circuit is the proof (e.g., the output), information corresponding to the private input is not shared with the verifier, and instead all that matters is that the private input is verified as a result of generating the proof.

In general, operating the ZK circuit to generate the proof is highly computationally intensive, memory intensive, and/or storage intensive while verifying the proof is a vastly more simple operation in terms of computational resources. This is due in part to the ZK circuit essentially being converted into a ZK key, which is generally a very large file, that is used to generate the proof, while the actual proof that is output is public and already verified.

In particular, according to one or more embodiments described herein, these techniques can allow for a company or other entity to be assured those persons (also referred to herein as “users”) have valid government-issued identity documents or other identity verifying document(s) (which may be referred to herein as a “document” or “document(s)” for brevity), and that the data on this document or these documents fulfills the identity requirements of the company or other entity, without ever seeing the document(s) itself. Further, the techniques herein allow for properties of the information (e.g., properties of the information contained in such documents) to be proved in a manner in which the information itself is not revealed to a data storage server or other third party, which allows for protection of sensitive information contained in, for example, the government-issued identity documents (or other identity verifying document(s)).

In some embodiments, an architecture is disclosed that includes a mobile device owned by the user (e.g., the person in possession of the government-issued identity documents or other identifying document(s)). As described in more detail herein, most of the processing takes place on the mobile device in order to protect and preserve the identifying information associated with the document(s). Most importantly, private information is not shared out of the user's device (e.g., the mobile device). This is achieved by the user of zero-knowledge proof technology. While some aspects of this technology are being used in various fields to preserve privacy, embodiments of the present disclosure are directed to a number of different implementations that enable the practical use of zero-knowledge proofs, particularly involving government-issued identity documents or other identifying document(s). Further, embodiments disclosed herein allow for the practical use of zero-knowledge proofs to take place on a low-resource user device to protect sensitive information that the user may not wish a requestor of such information to be privy to.

Embodiments are not limited to the illustrative examples contained herein, nor are embodiments limited to particular forms of identification, or even merely to identification documents. Instead, embodiments described herein allow for the application of zero-knowledge (ZK) proofs, ZK circuits, and other methodologies related to performance of ZK algorithms to a wide range of inputs in a wide range of contexts that arise in the field of cryptography.

For example, one embodiment of interest described herein relates to the deployment and processing of ZK circuits within a mobile device. Due to the large amount of computing resources (e.g., processing resources, memory resources, etc.) that are generally required to utilize ZK circuits to solve ZK proofs, current approaches may have difficulties in processing such ZK algorithms given the computing resource constraints inherent in mobile devices, such as smart phones, tablets, phablets, etc. However, embodiments of the present disclosure provide for parametrization of object and/or fields that relate to pertinent information used to solve ZK algorithms to generate ZK proofs to vastly reduce the complexity of ZK circuits, thereby allowing for ZK circuits to be deployed on a mobile device and efficiently solved to generate ZK proofs.

Yet another embodiment of interest described herein relates specifically to utilization of ZK techniques to prove information involving government-issued identity documents or other identifying document(s) without disclosing such sensitive information to the verifier. In general, non-limiting examples of these scenarios are presented herein in order to allow the reader to understand the concepts described herein, but such examples are not intended to be limiting.

As will be appreciated, ZK circuits generally operate with a fixed number of equations that can be solved by the circuit. Accordingly, this implies that a fixed number of inputs must be provided as private inputs to the ZK circuit to correspond to the fixed number of equations the ZK circuit operates on. While this feature can allow for a wide variety of complicated operations to be performed, the input data (e.g., the size, quantity of bits, etc.) of the input data must generally also be fixed. However, as described herein, not all information that may be of interest is fixed. That is, some information that can be of interest for processing utilizing a ZK circuit may be dynamic. In current approaches, handling of dynamic and/or dynamically stored information by a ZK circuit is cumbersome if not impossible. However, embodiments described herein allow for such dynamic and/or dynamically stored information to be parameterized in ways that can allow for processing by a ZK circuit.

### BRIEF DESCRIPTION OF THE DRA WINGS

The embodiments herein may be better understood by referring to the following description in conjunction with the accompanying drawings in which like reference numerals may indicate identically or functionally similar elements, of which:

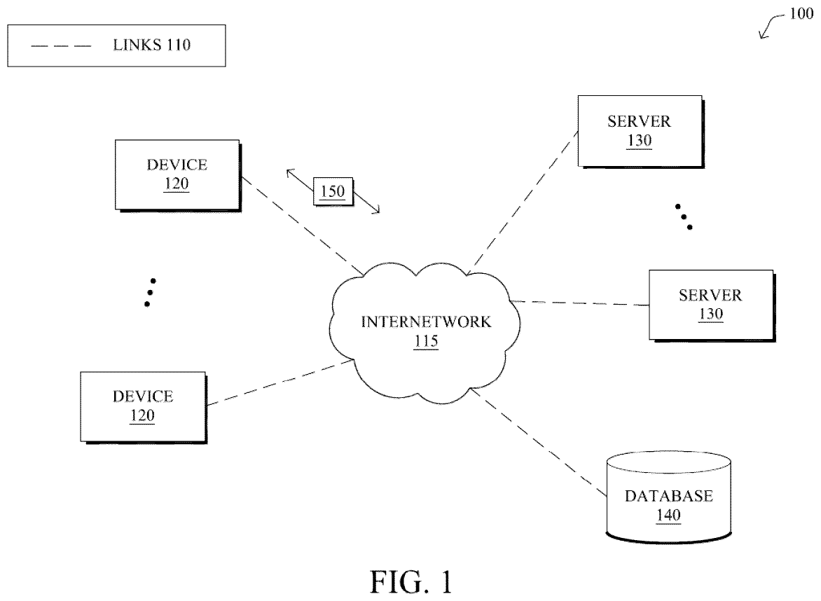

FIG. 1 illustrates an example simplified computer network;

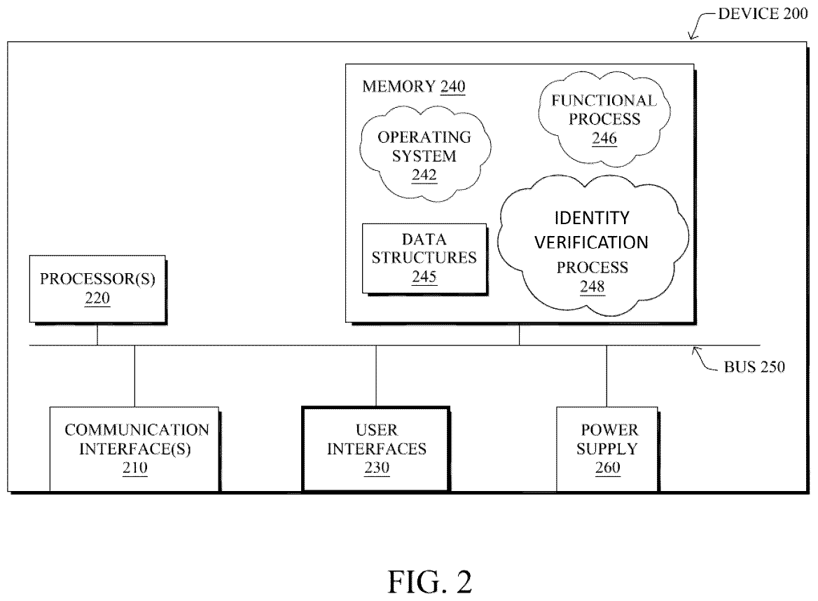

FIG. 2 illustrates an example of a computing device;

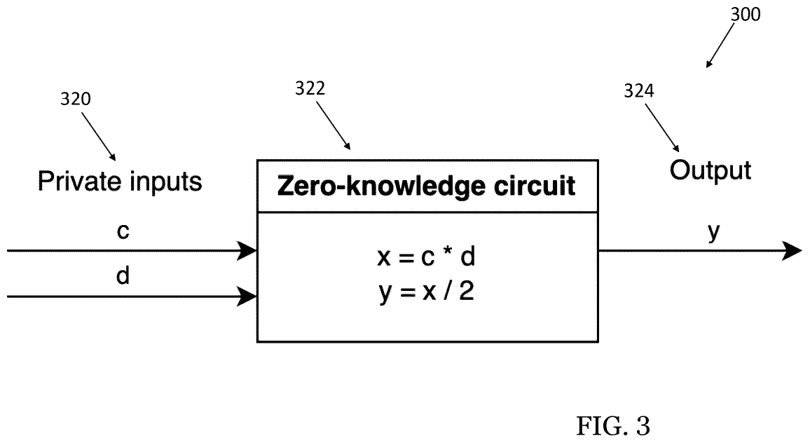

FIG. 3 illustrates an example system including a zero-knowledge circuit;

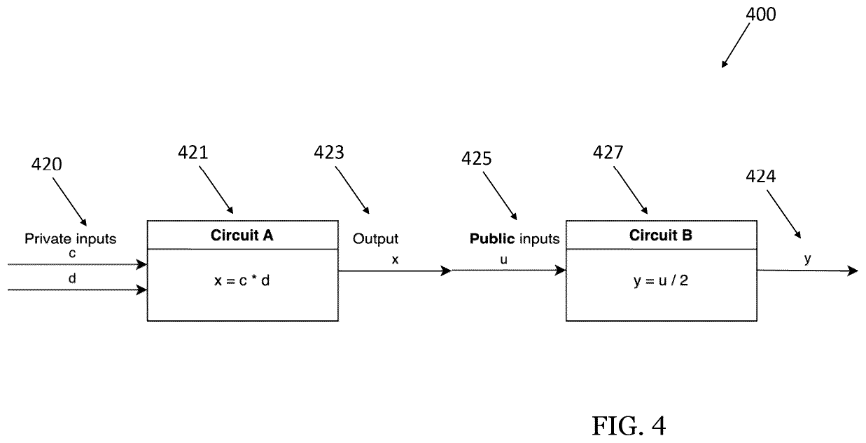

FIG. 4 illustrates an example system that includes two chained circuits; and

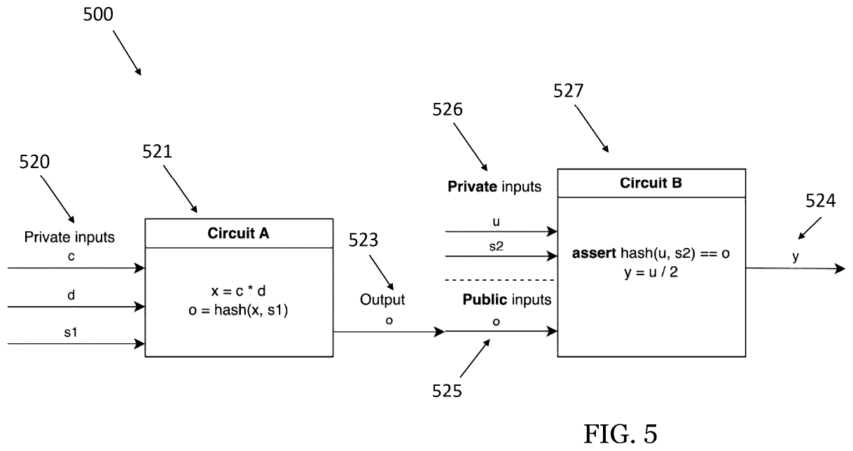

FIG. 5 illustrates an example system that illustrates circuit chaining with privacy preservation in accordance with one or more embodiments of the disclosure.

### DESCRIPTION OF EXAMPLE EMBODIMENTS

A computer network is a distributed collection of nodes (e.g., transmitters, receivers, transceivers, etc.) interconnected by communication links and segments for transporting signals or data between the nodes, such as personal computers, workstations, mobile devices, servers, routers, or other devices. Many types of computer networks are available, including, but not limited to, local area networks (LANs), wide area networks (WANs), cellular networks, broadband networks, infrastructure or backhaul networks, and many others.

FIG. 1 illustrates an example, and simplified, computer network 100. As shown, computer network 100 may contain various devices communicating over links 110 and an internetwork 115, such as end devices 120, servers 130, databases 140 (which may be part of servers 130 or in communication with and under the control of servers 130), and other devices as will be appreciated by those skilled in the art. Data transmissions 150 (e.g., packets, frames, messages, transmission signals, etc.) may be exchanged among the nodes/devices of the computer network 100 using predefined communication protocols where appropriate over links 110. In this context, a protocol consists of a set of rules defining how the nodes interact with each other.

Notably, the computer network 100 may comprise various individual networks intercommunicating with each other, such as LANs, WANs, cellular/LTE networks, and so on, and may include any number of wired or wireless links between the devices, accordingly. Note also that while links 110 are shown generically interconnecting with the internetwork 115, any number of intermediate devices (e.g., routers, switches, firewalls, etc.) may actually make up the composition of the computer network 100 and internetwork 115, and the view shown herein is merely a simplified illustration.

End devices 120 may comprise different types of devices, such as, e.g., personal computers, desktop computers, laptop computers, mobile devices, tablets, smartphones, wearable electronic devices (e.g., smart watches), smart televisions, set-top devices for televisions, workstations, smart vehicles, terminals, kiosks, automated teller machines (ATMs), applications running on such devices, and so on, often interfaces with human users, though not necessarily. For instance, end devices 120 may also comprise sensors, actuators, drones, automated vehicles, other “Internet of Things” (IoT) devices, and so on, configured generally to obtain, process, or act on data.

Servers 130 and/or databases 140 may comprise singular servers and/or databases, server and/or database farms, cloud-based server and/or database services, network attached storage (SAN), and any other type or configuration of computing devices that provides computing and/or storage services as will be appreciated by those skilled in the art. Servers 130 and/or databases 140 may be centralized (i.e., processing and/or storage occurring on a single device or within a single location of devices) or distributed/decentralized (i.e., processing and/or storage occurring across multiple devices or across a plurality of locations). Notably, for example, servers 130 and/or databases 140 may be deployed on the premises of an enterprise or may be cloud-based, such as the Amazon® “Simple Storage Service” (S3).

FIG. 2 is a simplified schematic block diagram of an example computing device (e.g., device 200) that may be used with one or more embodiments described herein (e.g., end device 120, servers 130, databases 140, etc.). Illustratively, device 200 may generally include one or more communication interfaces (e.g., communication interfaces 210), one or more processors (e.g., processor(s) 220), and a memory 240 interconnected by a system bus 250 or other dedicated circuitry and is powered by a power supply system 260. Additionally, the device 200, where required, may comprise one or more user interfaces 230 configured to solicit and receive user input (input/output or “I/O” components, such as displays, keyboards, touchscreens, and so on).

The communication interfaces 210 include the mechanical, electrical, and signaling circuitry for communicating data over wired and/or wireless links of a communication network.

The memory 240 includes a plurality of storage locations that are addressable by the processor(s) 220 for storing software programs and data structures associated with the embodiments described herein. The processor(s) 220 may comprise necessary elements or logic adapted to execute the software programs and manipulate the data structures 245 (e.g., encryption and decryption keys, such as public-private key pairs, as described below). An operating system 242, portions of which are typically resident in memory 240 and executed by the processor(s) 220, functionally organizes the device by, among other things, invoking operations in support of software processors and/or services executing on the device. Illustratively, these software processes and/or services may include one or more functional processes 246 (e.g., specific to functionality of the device), an example “identity verification” process 248 that is configured to perform the operations described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

--Identity Verification with Privacy Preservation--

As discussed above, embodiments of the present disclosure provide for an architecture that allows for a user to control identifying information (e.g., identity information) that is provided to a company, organization, or other entity without the need to provide a physical document, such as a government-issued identity document. By processing and storing pertinent information associated with such government-issued identity documents on a device that is owned by the user (e.g., a smartphone, tablet, phablet, mobile computing device, etc.) private information associated with the government-issued identity document (or other sensitive document) can be withheld from the company, organization, or other entity while still providing necessary or required identifying information to the company, organization, or other entity. As described herein, this can be realized through the use of zero-knowledge proof technology.

Further, as described above, one or more embodiments described herein provide for efficient deployment and processing of ZK circuits within a mobile device. As mentioned above, due to the large amount of computing resources (e.g., processing resources, memory resources, etc.) that are generally required to utilize ZK circuits to solve ZK proofs, current approaches may have difficulties in processing such ZK algorithms given the computing resource constraints inherent in mobile devices, such as smart phones, tablets, phablets, etc. In contrast to these current approaches, embodiments described herein allow for parameterization of various objects and/or fields to reduce the overall computational cost of processing ZK circuits, thereby allowing for a reduction in computational intensity such that one or more ZK circuits may be processed within the computing resource constraints inherent in mobile devices to provide verification of information with privacy preservation.

In some embodiments, an application can be installed on a device associated with the user to facilitate control of the amount of identity information that is provided to a company, organization, or other entity in a manner that allows the user to protect or otherwise hide some or all personal information while fulfilling identity requirements of the company, organization, or other entity.

In accordance with one or more embodiments of the disclosure, an application can be installed on the device associated with the user. The application can receive and/or process the government-issued identity document (or other sensitive document), which can be referred to as an “ID” or “IDs,” given the context of the disclosure, and can generate cryptographic proofs that the received document (e.g., the government-issued identity document) fulfills certain identity requirements associated with the user. Examples of such requirements can include age (e.g., over eighteen years of age, over 21 years of age), residency (e.g., resident of a particular country), citizenship (e.g., citizen of a particular country), etc.

In a non-limiting example involving an ICAO ID, a flow of operations in accordance with the disclosure may include one or more of the following. At the outset, it is noted that an application in accordance with the disclosure may read the minimum information needed to verify the digital ID and that the following ICAO ID example is merely provided in an illustrative and, hence, non-limiting manner. Accordingly, similar techniques as disclosed herein are applicable to other types of information that can be verified using a ZK proof, not limited particularly to ID documents or even to IDs, as the techniques herein read the minimum information needed to verify digital (e.g., cryptographic) information and provide proof that the information of interest is verified without providing the information itself.

1. The user takes their ICAO 9303 standard-compliant government-issued ID (or other government-issued identity document) and presents it to an application (e.g., an application that is executed on the user's device). Although ICAO 9303 standard-compliant government-issued IDs are discussed herein for the purpose of clarity, it will be appreciated that the techniques described herein apply to any government-issued identity document or other identity document. That is, the techniques described herein are applicable to any document or ID that has a corresponding digital counterpart including, but not limited to, a mobile digital driver's license, India's Aadhaar, and various other digital ID initiatives, among other possibilities. However, it is noted that the techniques described herein are especially applicable to documents or IDs that contain some type of cryptographic information and/or signature.
a. ICAO 9303 is an international standard that governs NFC-enabled ID documents, including driver's licenses, passports, credit cards, and other identifying documents. The NFC chip of these documents contains a digital copy of the ID, together with information on how to verify its cryptographic authenticity. The chip contains a number of data groups, one of which is of particular interest is the Machine-Readable Zone (MRZ) that contains the identity details of the holder, the holder's photo as printed on the document, and the Document Security Object (SOD), which is used to verify the authenticity of the ID. The SOD contains a number of objects, such as the LDSSecurityObject (LDS), which contains the hashes of all data groups, and the SignedAttributes object, which contains the hash of the LDS. Then, the hash of the SignedAttributes object is signed by a X.509 certificate called the Document Signing Certificate (DSC), usually also found in the SOD. Finally, the DSC is signed by a country-level certificate, the public key of which is usually published and updated by the respective issuing government. Verifying that all of these hashes and signatures verifies the authenticity of the document.

2. The application may then apply visual optical character recognition (OCR) to the standard-compliant government-issued ID (or other government-issued identity document) to read information on the first page (or any other page, as necessary) of the standard-compliant government-issued ID (or other government-issued identity document), and specifically, the printed Machine Readable Zone (MRZ) (in the case of ICAO IDs) of the standard-compliant government-issued ID (or other government-issued identity document).

3. The application may then scan the NFC chip of the standard-compliant government-issued ID (or other government-issued identity document) and may read the Document Security Object (SOD) (in the case of ICAO IDs) from the standard-compliant government-issued ID (or other government-issued identity document).
a. It is noted that the NFC chip holds a lot of data which is usually read, and it can take upwards of 10 seconds to read all of this data, which may worsen the user experience.
b. In order to improve the user experience, data minimization techniques may be applied in accordance with the disclosure to only read the minimum required information from the ID. For example, in some embodiments only the SOD and MRZ may be needed to verify the document and, accordingly only the SOD and MRZ may be read. Embodiments are not so limited, however, and other combinations of information may be selectively read the minimum required information from the ID.
c. In some embodiments, the user information (e.g., valuable identifying user information) is maintained in a separate NFC object containing the MRZ. As a result, reading the MRZ from the NFC is key to ensure data correctness. However, this process may also take valuable user time.
d. In order to improve the user experience when retrieving the information (e.g., the MRZ), embodiments herein allow for avoidance of scanning the MRZ from the NFC by instead comparing the hash of the OCR scanned MRZ with a hash stored in the SOD. However, it is still possible to scan the MRZ from the chip in the event that a mismatch between the hash of the OCR scanned MRZ with and the hash stored in the SOD.

4. In some embodiments, the SOD can be broken down into a minimum quantity of data required to verify the authenticity of the document, for example, the LDSSecurityObject, the SignedAttributes, and/or the Document Signing Certificate objects.

5. In some embodiments, the MRZ, the LDSSecurityObject, and the SignedAttributes objects can be labeled as private data and the identity requirements which have to be proven can be labeled as public data. The private and the public data can then be provided (e.g., fed) to a zero-knowledge (ZK) engine. The ZK engine may include processing resources configured to perform various processing functions using the private and the public data, as described herein.
a. As will be appreciated, zero-knowledge proofs are a cryptographic method for “proving” that some data has specific properties without revealing the data. The properties that the data must hold may be defined in a circuit. Fundamentally, a circuit has a set of inputs (labeled either public or private), it performs a set of basic arithmetic equations with these inputs, and produces a public output. A circuit is fulfilled when its inputs satisfy all of the equations, and because of that, they are called constraints. In this way, requirements for that data can be coded, even including complex cryptographic relationships, such as signature verification. A ZK circuit has the special property that if there exists a set of inputs which satisfy it, a proof that this circuit has been satisfied can be produced. The proof can be verified by another party, independently of the inputs, and it proves that whoever generated the proof knows a set of inputs which satisfy it, but crucially, the private inputs are not contained in the proof. Public inputs, on the other hand, are contained in the proof, as is the output of the circuit.

An example of a ZK circuit would be one which allows a party to prove that they know a valid signature corresponding to a well-known public key, without revealing that signature. The signature would be a private input, the public key would be a public input, and the constraints will encode the mathematical rules which must be satisfied in order to show that the signature is indeed signed by the identity of the public key. In this situation, the only way to generate a valid proof is to have a valid signature, and the proof will not contain the signature-just the fact that the party which produced the proof knows a valid signature.

Most widespread ZK proving systems, such as Groth 16, among others, require that the circuit is converted into a zero-knowledge key, and that key be used to generate a proof alongside the inputs. In the rest of this document, when we use the term “circuit,” we mean both the arithmetic relations, as well as that key. Such keys are usually very large in size, easily reaching gigabytes. Accordingly, the proving process can have high memory and computational requirements, and the computational complexity can increase exponentially with the number of constraints.

6. Continuing with the non-limiting example above, the ZK engine may output a set of ZK proofs, which mathematically prove that the requirements in the public data are met by the presented private data. As discussed above, no part of the private data is included in the resulting proofs, and nothing can be inferred about the private data from the proofs.

The design of this ZK engine may involve a number of unique implementations, described herein, to work around inherent limitations of ZK and/or incompatibilities between ZK proofs and the ICAO standard, although aspects of the disclosure are applicable to other standards and/or cryptographic methodologies.

In general, the data structures needed to verify an ID, such as a standard-compliant government-issued IDs or other such document, particularly in connection with the ICAO standard may be dynamic in structure, size, and may require different cryptographic algorithms to be processed.

In general, ZK-based computation is not Turing complete, and does not work well with dynamic data, because a ZK circuit always reduces to a fixed number of computational operations in the end. Fixed operations work best if the input data is fixed in structure as well. However, this is not the case for the ICAO standard, where the LDSSecurityObject and the SignedAttributes objects are defined in loose terms (specifically, in section 4.6.2 of Part 10 of the ICAO 9303 standard, and section 5.1 of RFC 3369, which describes the SignedData structure), where the locations of data elements, and the overall size of the objects, are dynamic and unpredictable-properties needed to efficiently process this data with a ZK circuit.

In order to address these and other issues, aspects of the present disclosure include multiple ways to convert a given MRZ object, LDSSecurityObject, and/or SignedAttributes object into a set of parameters, which can be used to reconstruct the objects. In some embodiments, these objects can be converted into a full set of such parameters. That is, the set of parameters can be a “full” set of parameters such that the set of parameters includes each parameter associated with each object that may be include on a chip, such as an NFC chip. For example, a “full” set of parameters in accordance with the disclosure can include each parameter associated with the various objects stored in an SOD file, such as a given LDSSecurityObject (LDS), SignedAttributes, etc., as well as other objects, such as the MRZ, etc., in addition to other objects that may be stored within a chip.

As mentioned herein, these and other objects can be processed with a series of hashing techniques and/or signature verification steps to verify a document.

Embodiments are not so limited, however, and in some embodiments, a set of parameters can include one or more subsets of parameters associated with the objects described herein. In the non-limiting example given here, a subset of such parameters may include only a portion of parameters associated with only a given MRZ, only a given LDSSecurityObject, only a given SignedAttributes, etc. That is, the techniques described herein allow for a single object, combination of objects, or a full set of objects to be converted into a single parameter, combination of parameters, or a full set of parameters to be used to reconstruct the objects.

This is important because, in the non-limiting ICAO example given herein, a chip (e.g., an NFC chip) can include various objects, such as the SOD, MRZ, LDS, etc. In general, these objects are dynamic (e.g., in size, location on the chip, etc.). However, in order to apply ZK proof techniques to such data, information must be determined in order to treat these objects as fixed.

It will be further appreciated that the techniques described herein are applicable to various objects and parameters that can be associated with any chip, device, storage mechanism, etc. that is capable of performing the operations described herein, particularly using a ZK proof paradigm, and the foregoing and forthcoming examples are merely illustrative.

Embodiments of the present disclosure are made possible through the inclusion and the analysis of large quantities (e.g., hundreds or even thousands) of real-world examples of relevant data objects to determine patterns in the structure of such objects. By understanding these real-world examples, e.g., examples of relevant objects and characteristics of the patterns of such relevant and/or real-world objects, the number of possible structures that can be used to represent the relevant data objects can be reduced in comparison to previous approaches. That is, utilizing only relevant objects and/or characteristics of the patterns of such relevant and/or real-world objects in the ZK circuits disclosed herein can allow for a reduction in the number of ZK circuits required to provide ZK proofs which, in turn, allows for the deployment of a reduced number of ZK circuits (particularly in architectures such as mobile devices that inherently have reduced computational resources when compared to large computing systems), as discussed in more detail below.

It is noted that, in addition to, or in the alternative to such techniques, embodiments of the present disclosure also can include the use of different cryptographic algorithms for different IDs during different phases of the verification of the objects. For example, the results of extensive research efforts to analyze hundreds of real-world examples of the relevant objects, combined with efforts directed to finding patterns in their structure allows embodiments of the present disclosure to reduce what may end up resulting in nearly infinite possible structures of these objects to a limited set of structures, e.g., a finite handleable set or subset of parameters that allow for processing of these objects in an efficient manner. Moreover, aspects of the present disclosure allow for identification of different objects and/or fields of IDs that may require different cryptographic algorithms to be used at different parts of the verification of these objects.
In addition to being able to “concretize” the structure of the objects, the ZK circuit of the present disclosure may also perform different cryptographic algorithms, such as hashing and signature verification, in order to validate the objects. Different IDs may require different algorithms at different steps of the process and, accordingly, the ZK circuit described herein can execute different algorithms at different steps of the process. That is, because ZK circuits may use different algorithms, various methodologies to parameterize objects can be utilized in accordance with the disclosure. Such algorithms can include which hashing functions should be applied to objects in order to provide verification and/or if an object is associated with a signature, what signature algorithm should be used to verify the same, among other possibilities.
For example, the SignedAttributes object is an ASNI structure containing different key-value pairs, without specific guidance on how large the object is or what specific pairs should be part of it. On the surface, it might seem impossible to design a practical ZK circuit for this.
   However, it has been determined in accordance with the disclosure that in practice only a few specific key-value pairs are generally being used and those specific key-value pairs are generally used in a specific order. An example parameter is whether a timestamp key-value pair is present. If it is determined that a timestamp key-value pair is present, it can be further determined how big the timestamp key-value pair is present is and where it might go in the object.
   Similarly, with other parameters associated with the key-value pairs, it is possible to reduce the complexity of handling unlimited theoretical possibilities of the object structure, to a limited set of possible reconstructions of these objects thereby facilitating operation of the ZK engine disclosed herein.
   Examples of how some objects can be represented with parameters, including a description of non-limiting exemplary parameters that may be used in connection with the techniques described herein are discussed in more detail below.
A template definition of a ZK circuit, able to process every specific reconstruction of the objects.
   In accordance with the disclosure, some examples herein are described in terms of a system that includes one ZK circuit, however, it will be appreciated that additional ZK circuits (e.g., a plurality of ZK circuits) that perform the operations herein can be utilized without departing from the scope of the disclosure. The example ZK circuit discussed herein is able to process a specific reconstruction of all the objects (e.g., for every possible reconstruction of the objects). Creating a ZK circuit in accordance with the disclosure is possible because every object reconstruction is of fixed size and structure.
   In addition to being able to process the objects in a ZK circuit, embodiments herein may also implement the relevant cryptographic algorithms needed to verify these objects, in efficient ZK language. In addition, every one of the ZK circuits of the disclosure also includes support for a specific set of algorithms. Stated alternatively, a given ZK circuit that supports a specific reconstruction of ID objects (for the non-limiting example described herein) also supports the relevant specific cryptographic algorithms to validate these objects.

Because we need to read the specific ID of the user to determine which ZK circuit can be used to process that, we cannot include the ZK circuit in the application as is the industry practice.

However, methodologies in accordance with the disclosure can provide for a way in which the user's client device can send the parameters of the objects of the user's ID as discussed above (which of course, don't contain private information) to a server, which then sends the relevant specific ZK circuit for these parameters back to the client. As mentioned above, the parameters do not contain private information and, accordingly, private information is not exposed to the server, thereby ensuring privacy of the information from the user's device.

Further, large ZK circuits are memory and computationally intensive, which may imply that large ZK circuits are too computationally expensive or too complex to be processed on a mobile device.

In general, the computational time to generate a proof of a ZK circuit increases exponentially with its size (and more specifically, the number of its constraints). The file size, and consequently the memory requirements, increase as well, to the point that some approaches may be unable to process or otherwise handle processing of generation of a proof of a ZK circuit.

However, methodologies in accordance with the disclosure can provide ways to split a ZK circuit, representing a large compound computation into separate circuits in a way which still represents the same large compound computation, ensures that the circuits cannot be used independently of each other, and ensures that no private information about the computation is leaked. These techniques may be referred to herein as “ZK circuit chaining” or “circuit chaining,” for brevity. One or more FIGS. herein illustrate these concepts.

For example, FIG. 3 illustrates an example system 300 including a zero-knowledge circuit. As shown in FIG. 3, the system 300 includes private inputs 320 (e.g., input c and input d), which are processed by a zero-knowledge (ZK) circuit 322 to produce an output 324 (e.g., the output y). The example ZK circuit 322 of FIG. 3 is a highly simplified ZK circuit that is meant to illustrate the general concept of a ZK circuit that receives two inputs (e.g., the private inputs 320), processes the same, and returns an output 324. The output 324 can be a public output in accordance with ZK techniques. That is, the output 324 may be provided to a verifier to prove that the private inputs 320 satisfy a condition in a manner that the private inputs 320 are not provided to the verifier, thereby protecting the information contained in the private inputs 320 from the verifier (or other entity) that is privy to the output 324.

As shown in FIG. 3, an example compound computation is performed with private inputs c and d, and it performs Equation 1 and Equation 2:

$$x = c * d \qquad Equation 1$$

$$y = \frac{x}{2} \qquad Equation 2$$

and outputs y as a result. It is noted that, in accordance with some embodiments the disclosure, the outputs are always public, while the inputs are always private. Embodiments are not so limited, however, and in other embodiments, some inputs and/or outputs (e.g., salted hashes, etc.) shared between the circuits shown in FIG. 5, for example, may be made public, among other possibilities.

However, as noted above, the computational intensity of processing data using ZK circuits can quickly become overwhelming. For example, for every input to the ZK circuit 322, the computational resources required to compute the output may grow exponentially, thereby quickly making a single ZK circuit, such as the ZK circuit 322, unreasonable for use, particularly in the context of mobile device deployments where computing resources are highly constrained.

One approach to counter these issues is to provide a “chained” ZK circuit (or “split” ZK circuit) where one circuit performs a portion of the computation, and another circuit performs a different portion of the computation. This is shown in FIG. 4.

FIG. 4 illustrates an example system 400 that includes two chained circuits (e.g., two “chained” or “split” ZK circuits). As mentioned above, the example shown in FIG. 4 may appear to be an obvious choice to reduce computational resources associated with the (single) ZK circuit 322 illustrated in FIG. 3.

As shown in FIG. 4, the system 400 includes private inputs 420 (e.g., input c and input d), which are processed by a first circuit 421 (e.g., CIRCUIT A) to produce an output 423 (e.g., the output x). A public input 425 (e.g., the input u) is then provided to a second circuit 427 (e.g., CIRCUIT B), which produces an output 424 (e.g., the output y).

That is, as shown in FIG. 4, in which the zero-knowledge circuit 322 of FIG. 3 is split into two discrete circuits (i.e., first circuit 421 and second circuit 427), the first circuit 421 takes private inputs c and d, performs Equation 1 to output x, and the second circuit 427 takes the public input 425 (e.g., the input u), performs Equation 2, and outputs y, where y is given by Equation 3:

$$y = \frac{u}{2} \qquad Equation 3$$

Taken together or separately, the examples of FIG. 3 and FIG. 4 may represent the same computation. For example, although these examples illustrate different circuits (e.g., ZK circuits), they can used to create separate ZK proofs (e.g., each ZK circuit described herein can produce a single separate proof) that may produce the same result, e.g., the output y of FIG. 3 may be the same as the output y of FIG. 4 numerically or otherwise and may therefore appear to a verifier to be proven.

An issue that may arise, however is that if a company, user, entity, etc. is responsible to verify two given proofs, as shown above in FIG. 3 and/or FIG. 4, it can be difficult to ensure these two (or more) proofs, as shown in the example of FIG. 4, are two parts of the same computation. That is, because a public input 425 is required in the example of FIG. 4 to be provided to the second circuit 427, and because each ZK circuit can produce a single separate proof, a potential to expose private information due to the public input u being provided to the second circuit 427 could cripple or, in the worst case, render the purpose of ZK proof techniques useless in the example approach of FIG. 4.

Stated alternatively, situations can arise where private information could be exposed using the simplistic circuit methodologies shown in FIG. 4 . . . . Accordingly, without extra checks, proofs, computations, etc., a nefarious actor could replace one of the proofs to try to fool the verifier into accepting an incorrect proof.

The obvious solution that some previous approaches may take, which is shown in FIG. 4, to this conundrum would therefore be to reveal the internal state of the computation, which should be passed on to the next circuit, by making some of the inputs of the circuit(s) public. For example, as shown in FIG. 4, the public input 425 (e.g., the input u) would be made public such that a verification entity can verify both proofs and, as a result, verify that x=u.

However, as mentioned above, approaches such as this may suffer from an unavoidable consequence that private information from the computation is leaked, thereby rendering the use of ZK circuits useless, at best and allowing sensitive or provide information to be made public, at worst.

Operationally, FIG. 5 illustrates an example system 500 that illustrates circuit chaining with privacy preservation in accordance with one or more embodiments of the disclosure. As shown in FIG. 5, the system 500 includes private inputs 520 (e.g., input c, input d, and input s1), which are processed by a first circuit 521 (e.g., CIRCUIT A) to produce an output 523. Private input 526 (e.g., the input u, the input s2, etc.) are provided along with a public input 525 to a second circuit 527 (e.g., CIRCUIT B), which then produces an output 524 (e.g., the output y). The private inputs s1 and s2 can be a “salt” (i.e., a cryptographic salt that is made up of random bits added to a string of bits before hashing).

That is, in accordance with the disclosure, additional private inputs (e.g., s1 and s2) are provided to the first circuit 521 and to the second circuit 527, respectively while maintaining privacy of the information contained in the private inputs 520 (e.g., c and d) to the first circuit 521 and while maintaining privacy of the information contained in the private inputs 526 (e.g., u) to the second circuit to ensure that the first circuit 521 and the second circuit 527 are able to provide a set of two ZK proofs that can be verified to be produced from the same compound computation. As mentioned above, each ZK circuit (e.g., the first circuit 521 and the second circuit 527, etc.) described herein can produce a single separate proof in accordance with the disclosure.

For example, as shown in FIG. 5, the first circuit 521 is configured to perform a computation using the private inputs 520 in accordance with Equation 1 and may also output a hash function of x and s1, as shown in Equation 4 as an output 532, which may be passed to the second circuit 527 as a public input 525 while the second circuit 527 asserts a hash function of u and s2 as shown in Equation 5:

$$hash ( x , s 1 ) \qquad Equation 4$$

$$hash ( u , s 2 ) = o \qquad Equation 5$$

where the hash is an arbitrary hashing algorithm taking an input and a salt (s1, s2).

In addition to receiving the public inputs 525 (e.g., the input o), the second circuit 527 may also receive private inputs 526 (e.g., the input u, the input s2) as mentioned above. The second circuit 527 may use Equation 5 to ensure that the first circuit 521 is providing verifiable inputs (e.g., that the first circuit 521 is “connected” with the second circuit 527 in order to provide reliable proofs) and therefore ensure that the output 524 (e.g., the output y) is true, and hence, a proof of the ZK circuits of FIG. 5.

That is, the second circuit 527 may use Equation 5 to ensure that the public input passed onto the circuit is actually the salted hash of the actual, private, intermediary input of the computation. This means that a proof of the second circuit proves that it received the real, unsalted, input corresponding to the published salted hash.

Stated alternatively, embodiments of the present disclosure provide for a universal method for circuits to pass on their internal state to the next, in a way that does not leak any information.

In some embodiments, if a verifier verifies the proofs of the circuit configurations shown in FIG. 5, all they have to check is that the output of the first circuit 521 (e.g., CIRCUIT A) equals the public input to the second circuit 527 (e.g., CIRCUIT B) considering the output of Equation 5, which is equivalent to “o.” If these values are determined to be equivalent (e.g., by leveraging the collision resistance property of hashing functions), the verifier can conclude that s1=s2 and x=u, without ever learning the values of, x, u, s1, s2.

As a result, embodiments described herein allow for the effective design and implementation of ZK circuits (e.g., separate ZK circuits) that can represent compound computations and/or systems that are capable of forming a chain of computation with respect to ZK circuits. Further, the above methodologies and circuitries can allow for compound circuits to pass any arbitrary internal state of the computation down the chain without revealing information and can allow the verifier to effectively verify the proofs, thereby ensuring that a set of proofs actually form the same compound computation without revealing any private information to a user. In some embodiments, there may be one ZK circuit for each type of computation (e.g., for each attribute and/or parameter) utilizing the private information, such as the SOD, MRZ, LDS, etc. of the non-limiting example given herein.

In some embodiments, the verification processes described herein can be split into multiple circuits. In a non-limiting example that follows, for example, the verification processes can be split into four circuits, although embodiments are not limited to this particular number of circuits and in some embodiments, greater than four circuits or less than four circuits may be utilized in accordance with the disclosure:

1. MRZ verifier
a. Private inputs: MRZ contents, salt
b. Public inputs: Identity requirements to be matched (e.g. age >18)
c. Computation: asserts the identity requirements against the MRZ
d. Output: salted hash of the MRZ

2. LDS verifier
a. Private inputs: LDS contents, salt, salted hash of the MRZ
b. Computation: asserts that the MRZ hash is contained in the expected location of the LDS
c. Output: salted hash of the LDS

3. SignedAttrs verifier
a. Private inputs: SignedAttrs contents, salt, salted hash of the LDS
b. Public inputs: whether to output a unique ID, and the salt to be used (more on that later)
c. Computation: asserts that the LDS hash is contained in the expected location of the SignedAttrs.
d. Output: salted hash of the SignedAttrs. If a unique ID is also requested, then output another salted hash of the SignedAttrs using the unique ID salt.

4. Signature verifier
a. Private inputs: salt, salted hash of the SignedAttrs, signature over the hash of the SignedAttrs
b. Public inputs: signing public key
c. Computation: asserts that when decrypting the signature using the given public key, we get the hash of the SignedAttrs

In some embodiments, in addition to a reduction in computational time to generate a proof, another benefit of the present disclosure and the of circuit chaining techniques described herein is that the circuits in the chain (e.g., the circuit chain of FIG. 5) can be downloaded in a sequence, and proofs can be generated over the downloaded circuits while the others are still being downloaded, accelerating the process for the user. That is, embodiments herein allow for parallel processing of complex circuit chains to enhance a user experience.

Another issue in the field that is addressed by the techniques of the disclosure is that many online businesses have problems with bots or people making multiple accounts, for example, to post fake content or to take advantage of one-time offers. This issue can be remedied with the methodologies described herein through the identity verification processes described herein.

For example, while verifying an ID, the circuits discussed above can output a salted hash of the SignedAttributes object. This hash can have the following properties:
For any arbitrary salt, the hash is unique for every ID.
Two hashes using different salts will always be unequal, even if coming from the same ID.
The hash does not reveal any other information. This is because there is enough entropy in the SignedAttributes object to make it practically impossible for someone to undertake a dictionary attack on the resulting hash, and reveal the object itself. And even if the object is somehow revealed, it does not contain any personally identifiable information.

This means that websites can use such salted hashes as a very efficient way to differentiate unique users, because, in accordance with the disclosure, each user has a unique yet private ID, and replacing such an ID becomes a highly complicated task. Further, because most applications use a different salt, the risk of misidentifying a particular user approaches zero, even if said users verify themselves with many different applications in an online environment.

Another issue that is addressed by the techniques of the disclosure is the possibility that a third party or nefarious user could access the circuits (e.g., the ZK circuits) described above. That is, due to the properties of ZK proofs, it may be possible to create and verify proofs for IDs just by having the relevant circuit information. Although this is a complicated task based on the foregoing, given that any circuit is generally allowed to be downloadable by a user, so that they can undergo verification, a nefarious actor may be able to engineer a process to retrieve certain information regarding the circuits described herein.

However, in accordance with the disclosure, when a user device presents the user's ID document parameters to the systems described herein to download the relevant circuit, the user will also include the signature of the SignedAttrs data structure, together with the DSC needed to verify it. Once the server has verified that this is an authentic signature, the server can check if this signature was used before to download a circuit. If it hasn't, the server will save the parameters corresponding to that signature and return the relevant circuit. If it has, it will compare the saved parameters with the ones received with the current request-if they are equal, the relevant circuit will be returned. If they are not, the request will be rejected.

This way, one ID can only ever be used to download one circuit. This mechanism steps on the uniqueness and sybil-resistant properties of the IDs to prevent attacks aimed at downloading all available circuits. Now, a successful attack would require a unique, authentic ID for every circuit to be downloaded, which is impractical and nearly impossible to achieve.

In closing, in accordance with the disclosure, a method as described herein (which can be executed by one or more processes, algorithms, applications, computer programs, etc. in conjunction with one or more hardware processors configured to execute instructions to perform such processes, algorithms, applications, computer programs, etc.) can include receiving, by a process, identifying information associated with a user of a user device. The method can further include separating, by the process, the identifying information into one or more subsets of information, wherein at least one subset of the identifying information includes a minimum quantity of data to verify the identifying information. The method can further include labeling, by the process, the at least one subset of the identifying information that includes the minimum quantity of data to verify the identifying information as private data and a different subset of the identifying information as public data. In some embodiments, the method can further include providing, by the process, the private data and the public data to a zero-knowledge engine and processing, by the zero-knowledge engine, the private data and the public data to verify an identity of the user without exposing at least the private data to an entity other than the user, as described herein.

In some embodiments, the identifying information is received by the process via optical character recognition. Embodiments are not so limited, however, and in some embodiments, the identifying information is received by the process via a near-field communication scan.

As discussed herein, the user device can comprise a device selected from a list consisting of: a smartphone, a mobile phone, a tablet, and a laptop computer. In many embodiments, the zero-knowledge engine is deployed on the user device, as mentioned above.

Further, in some embodiments, the zero-knowledge engine can comprise a plurality of zero-knowledge circuits and each zero-knowledge circuit among the plurality of zero-knowledge circuits is configured to perform a particular step in a computation associated with processing the private data and the public data to verify an identity of the user. In such embodiments, a first zero-knowledge circuit among the plurality of zero-knowledge circuits can be configured to perform a calculation involving the private data as part of processing the private data and the public data to verify an identity of the user and a second zero-knowledge circuit among the plurality of zero-knowledge circuits can be configured to perform a calculation involving the public data as part of processing the private data and the public data to verify an identity of the user.

Moreover, in such embodiments, the first zero-knowledge circuit among the plurality of zero-knowledge circuits can be configured to execute a first hash function, the first hash function having as inputs a result of a compound computation involving private inputs and a first salt and the second zero-knowledge circuit among the plurality of zero-knowledge circuits can be configured to execute a second hash function, the second hash function having as inputs a result of a compound computation involving public inputs and a second salt.

As discussed above, the private data can include data selected from a list consisting of: information contained in a Machine Readable Zone of an identification document, information contained in a Document Security Object of the identification document, an LDSSecurityObject, and a SignedAttributes object associated with the identification document. In addition to, or in the alternative, in some embodiments, the process can receive the identifying information associated with the user from a government issued identification document.

A non-limiting real-world example of embodiments of the disclosure follows. Assume that a person would like to gain entry to a venue (e.g., a bar, nightclub, discotheque, etc.) that has a minimum age requirement. In such scenarios, a bouncer or other person at the door may demand that the potential entrant show identification (e.g., a government issued identification document) to prove that they meet the minimum age required for entry. However, by providing the identification to the bouncer, the potential entrant may expose other irrelevant information to the bouncer, such as their name, address, etc. The potential entrant may not feel comfortable providing this irrelevant information to a stranger (e.g., the bouncer). However, in accordance with the disclosure, the entrants age can be readily verified without exposing the other information to the bouncer, thereby increasing the safety of the entrant while still providing the relevant information for entry.

In some embodiments, a user device (e.g., a smartphone, mobile phone, phablet, tablet, laptop, etc.) can include a memory, a zero-knowledge engine, and a processor coupled to the memory. In such embodiments, the processor can be configured to execute instructions stored in the memory to receive identifying information associated with a user of a user device; separate the identifying information into one or more subsets of information, wherein at least one subset of the identifying information includes a minimum quantity of data to verify the identifying information; label the at least one subset of the identifying information that includes the minimum quantity of data to verify the identifying information as private data and a different subset of the identifying information as public data; provide the private data and the public data to the zero-knowledge engine; and cause the processor to process the private data and the public data to verify an identity of the user without exposing at least the private data to an entity other than the user.

In some embodiments, a tangible, non-transitory, computer-readable medium storing program instructions that cause a device to execute a process comprising: receiving identifying information associated with a user of a user device; separating the identifying information into one or more subsets of information, wherein at least one subset of the identifying information includes a minimum quantity of data to verify the identifying information; labeling the at least one subset of the identifying information that includes the minimum quantity of data to verify the identifying information as private data and a different subset of the identifying information as public data; providing the private data and the public data to a zero-knowledge engine; and processing, by the zero-knowledge engine, the private data and the public data to verify an identity of the user without exposing at least the private data to an entity other than the user.

The following examples show an example of a document object in accordance with the present disclosure, along with a table of what parameters may be used to represent this object. These parameters correspond to knowledge of the size and structure of the object, including the location of the key fields the ZK circuits described herein may use to verify the document.

Although particular parameters are illustrated in the following examples of pseudocode, tables, and/or examples, the disclosure is not limited specifically to these parameters, values, attributes, fields, etc. Accordingly, additional parameters, values, attributes, fields, etc. that are not explicitly illustrated in the following section are contemplated within the scope of the disclosure.

The SignedAttributes structure is largely a store of different key-value pairs in special DER-encoded ASNI syntax. Here's two examples.

```
SignedAttributes example #1
SEQUENCE -- SignedAttributes
  SEQUENCE
    OID 1.2.840.113549.1.9.3 contentType -- attrType
    SET -- attrValues
      OID 1.2.840.113549.1.7.1 data
  SEQUENCE
    OID 1.2.840.113549.1.9.5 signingTime -- attrType
    SET -- attrValues
      UTCTime 2022-01-01 12:34:56 UTC -- example value
  SEQUENCE
    OID 1.2.840.113549.1.9.4 messageDigest -- attrType
    SET -- attrValues
      OCTET STRING [redacted hash of LDSSecurityObject]
```

| Parameter name | Value | Connection to example |
|---|---|---|
| dataOIDPresent | true | The object includes a data element |
| timestampPresent | true | The object includes a signingTime element |

We notice that this example has data and signing Time elements.

```
SignedAttributes example #2
SEQUENCE -- SignedAttributes
  SEQUENCE
    OID 1.2.840.113549.1.9.3 contentType -- attrType
    SET -- attrValues
      OID 2.23.136.1.1.1 ldsSecurityObject
  SEQUENCE
    OID 1.2.840.113549.1.9.4 messageDigest -- attrType
    SET -- attrValues
      OCTET STRING [redacted hash of LDSSecurityObject]
```

| Parameter name based on which a circuit will be chosen | | |
|---|---|---|
| to handle the request | Value | Connection to example |
| dataOIDPresent | false | There is no data element |
| timestampPresent | false | There is no signingTime |
| | | element |

Unlike the previous example, this object has neither of these elements.

The LDSSecurityObject can also vary in size depending on multiple parameters.

An extract of the SOD containing the LDSSecurityObject can be found below. It contains the LDSSecurityObject version, the digest algorithm used to hash the data groups, and an additional optional LDSVersionInfo object (present only in the first example):

```
LDS example #1
SEQUENCE -- LDSSecurityObject
  INTEGER 1 -- version
  SEQUENCE
    OID 2.16.840.1.101.3.4.2.1 sha256 -- digestAlgorithm
  SEQUENCE - dataGroupHashValues
    SEQUENCE
      INTEGER 1 -- dataGroupNumber
      OCTET STRING [redacted sha256 hash of data group 1] --
    dataGroupHashValue
    SEQUENCE
      INTEGER 2 -- dataGroupNumber
      OCTET STRING [redacted sha256 hash of data group 2] --
    dataGroupHashValues
    SEQUENCE
      INTEGER 14 -- dataGroupNumber
      OCTET STRING [redacted sha256 hash of data group 14] --
    dataGroupHashValues
  SEQUENCE -- LDSVersionInfo
    PrintableString 0108 -- ldsVersion
    PrintableString 030000 -- unicodeVersion
```

| Parameter name based on which a circuit will be | | |
|---|---|---|
| chosen to handle the request | Value | Connection to example |
| dgDigestAlgorithm | sha256 | The data group hashes use sha256 |
| dgCount | 3 | This object contains 3 data groups |
| IdsVersionInfoPresent | true | The object contains an |
| | | LDSVersionInfo |
| digestNullPresent | false | There is no null byte after the |
| | | digest algorithm |
| IdsDigestAlgorithm | sha256 | The whole LDS object needs to be |
| | | hashed with sha256 |

The key parameter determining the size of the LDS object is the number of data groups, and the digest algorithm used for the data group hashes. There are two other details in this structure which may or may not be present—the ldsVersionInfoPresent and the digestNullPresent. Finally, to continue with the verification, the hash of the LDS object needs to be computed with a specific digest algorithm, which might be different from the data group hashes algorithm.

```
LDS example #2
SEQUENCE -- LDSSecurityObject
  INTEGER 0 -- version
  SEQUENCE
    OID 1.3.14.3.2.26 sha1 -- digestAlgorithm
  SEQUENCE -- dataGroupHashValues
    SEQUENCE
      INTEGER 1 -- dataGroupNumber
      OCTET STRING [redacted sha1 hash of data group 1] --
    dataGroupHashValues
    SEQUENCE
      INTEGER 2 -- dataGroupNumber
      OCTET STRING [redacted sha1 hash of data group 2] --
    dataGroupHashValues
    SEQUENCE
      INTEGER 3 -- dataGroupNumber
      OCTET STRING [redacted sha1 hash of data group 3] --
    dataGroupHashValues
    SEQUENCE
      INTEGER 11 -- dataGroupNumber
      OCTET STRING [redacted sha1 hash of data group 11] --
    dataGroupHashValues
    SEQUENCE
      INTEGER 12 -- dataGroupNumber
      OCTET STRING [redacted sha1 hash of data group 12] --
    dataGroupHashValues
    SEQUENCE
      INTEGER 14 -- dataGroupNumber
      OCTET STRING [redacted sha1 hash of data group 14] --
    dataGroupHashValues
```

| Parameter name based on which a circuit will | | |
|---|---|---|
| be chosen to handle the request | Value | Connection to example |
| dgDigestAlgorithm | sha1 | The data group hashes use shal |
| dgCount | 6 | There are 6 data groups in this |
| | | LDSSecurityObject |
| IdsVersionInfoPresent | false | The object does not contain an |
| | | LDSVersionInfo |
| digestNullPresent | false | There is no null byte after the |
| | | digest algorithm |
| IdsDigestAlgorithm | sha256 | The whole LDS object needs to be |
| | | hashed with sha256 |

Using parameters like these, aspects of the disclosure allow for calculation of the possible sizes of the different possible LDS objects, as well as the expected locations of the data elements required to process inside of them, and prepare circuits to verify these objects accordingly.

It should be noted that while certain steps within the procedures described herein may be optional as described above, the steps shown in one or more of the FIGS. are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while various procedures described herein may be described separately, certain steps from each procedure may be incorporated into each other procedure, and the procedures are not meant to be mutually exclusive.

The techniques described herein, provide for a “zero-knowledge” proof paradigm that, among other things, allows for verification of information, such as identity verification, in a privacy-preserving manner. That is, embodiments discussed herein allow for information that is intended to be kept private to remain private while allowing verification of such information to be viewable only by intended recipients. In particular, according to one or more embodiments described herein, these techniques can allow for a company or other entity to be assured those persons having valid government-issued identity documents or other identity verifying document(s), and that the data on this document or these documents fulfills the identity requirements of the company or other entity, without ever seeing the document(s) itself. Further, the techniques herein allow for visibility to a data storage server, or any other third party, to be hidden, inaccessible, and/or un-viewable such that any data storage server or other third party is not able to see or otherwise view the government-issued identity documents (or other identity verifying document(s)).

Further, embodiments herein relate to the deployment and processing of ZK circuits within a mobile device. Due to the large amount of computing resources (e.g., processing resources, memory resources, etc.) that are generally required to utilize ZK circuits to solve ZK proofs, current approaches may have difficulties in processing such ZK algorithms given the computing resource constraints inherent in mobile devices, such as smart phones, tablets, phablets, etc. However, embodiments of the present disclosure provide for parametrization of object(s) and/or fields that relate to pertinent information used to solve ZK algorithms to generate ZK proofs to vastly reduce the complexity of ZK circuits, thereby allowing for ZK circuits to be deployed on a mobile device and efficiently solved to generate ZK proofs.

While there have been shown and described illustrative embodiments that relate generally to zero-knowledge data management networks, it is to be understood that various other adaptations and modifications may be made within the scope of the embodiments herein. For example, though the disclosure was often described with respect to using public and private keys, those skilled in the art should understand that this was done only for illustrative purpose and without limitations, and the techniques herein may use any asymmetric encryption technique with encryption and decryption keys or techniques.

While the embodiments may have been demonstrated with respect to certain communication environments, physical environments, or device form factors, other configurations may be conceived by those skilled in the art that would remain within the contemplated subject matter of the description above. For example, while different functions have been described as being performed on various servers or devices, certain functions may be performed on the same physical server or on the same virtual server. Also, some functions which were described separately (e.g., and distributed between different servers) may be performed by a single process (e.g., a single software program configured to perform multiple functions described herein.

Notably, as described herein, any “device” may generally imply any device with appropriate credentials or authority to act on behalf of a particular entity. For example, a “source device” may imply any of one or more source devices, such as a smartphone, tablet, computer, etc., of a particular user, company, institution, etc., that has the necessary encryption keys to create source-encrypted source data, and so on. As such, a “source” herein may imply any of one or more source devices that is authorized as a source of source data (e.g., a user logged into any one of his or her devices). Likewise, a “particular recipient device” may imply any of one or more recipient devices authorized to receive data, e.g., any device with the necessary credentials and decryption keys (e.g., recipient private keys). Similar understanding will be readily made by those skilled in the art to include such devices as one or more storage servers, one or more attestation servers, one or more controller devices, one or more governmental devices, one or more regulatory compliance/organization devices, one or more financial institution devices, one or more retail company devices, one or more auditing system devices, one or more medical system devices, one or more user devices, and so on. As such, the description herein, as well as the appended claims, are meant to include any appropriate configuration of authorized devices acting on behalf of a named entity (e.g., a server farm as opposed to a single server, any number of a user's many devices, etc.).

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
receiving, by a process, identifying information associated with a user of a user device;
separating, by the process, the identifying information into one or more subsets of information, wherein at least one subset of the identifying information includes a minimum quantity of data to verify the identifying information;
labeling, by the process, the at least one subset of the identifying information that includes the minimum quantity of data to verify the identifying information as private data and a different subset of the identifying information as public data;
providing, by the process, the private data and the public data to a zero-knowledge engine; and
processing, by the zero-knowledge engine, the private data and the public data to verify an identity of the user without exposing at least the private data to an entity other than the user.

2. The method of claim 1, wherein the identifying information is received by the process via optical character recognition.

3. The method of claim 1, wherein the identifying information is received by the process via a near-field communication scan.

4. The method of claim 1, wherein the user device comprises a device selected from a list consisting of: a smartphone, a mobile phone, a tablet, and a laptop computer.

5. The method of claim 1, wherein the zero-knowledge engine is deployed on the user device.

6. The method of claim 1, wherein:
the zero-knowledge engine comprises a plurality of zero-knowledge circuits, and
each zero-knowledge circuit among the plurality of zero-knowledge circuits is configured to perform a particular step in a computation associated with processing the private data and the public data to verify an identity of the user.

7. The method of claim 6, wherein:
a first zero-knowledge circuit among the plurality of zero-knowledge circuits is configured to perform a calculation involving the private data as part of processing the private data and the public data to verify an identity of the user, and
a second zero-knowledge circuit among the plurality of zero-knowledge circuits is configured to perform a calculation involving the public data as part of processing the private data and the public data to verify an identity of the user.

8. The method of claim 7, wherein:
the first zero-knowledge circuit among the plurality of zero-knowledge circuits is configured to execute a first hash function, the first hash function having as inputs a result of a compound computation involving private inputs and a first salt, and
the second zero-knowledge circuit among the plurality of zero-knowledge circuits is configured to execute a second hash function, the second hash function having as inputs a result of a compound computation involving public inputs and a second salt.

9. The method of claim 1, wherein the private data includes data selected from a list consisting of: information contained in a Machine Readable Zone of an identification document, information contained in a Document Security Object of the identification document, an LDSSecurityObject, and a SignedAttributes object associated with the identification document.

10. The method of claim 1, wherein the process receives the identifying information associated with the user from a government issued identification document.

11. A user device, comprising:
a memory;
a zero-knowledge engine; and
a processor coupled to the memory, wherein the processor is configured to execute instructions stored in the memory to:
receive identifying information associated with a user of a user device;
separate the identifying information into one or more subsets of information, wherein at least one subset of the identifying information includes a minimum quantity of data to verify the identifying information;
label the at least one subset of the identifying information that includes the minimum quantity of data to verify the identifying information as private data and a different subset of the identifying information as public data;
provide the private data and the public data to the zero-knowledge engine; and
cause the processor to process the private data and the public data to verify an identity of the user without exposing at least the private data to an entity other than the user.

12. The user device of claim 11, wherein the identifying information is received via optical character recognition.

13. The user device of claim 11, wherein the identifying information is received via a near-field communication scan.

14. The user device of claim 11, wherein the user device comprises a device selected from a list consisting of: a smartphone, a mobile phone, a tablet, and a laptop computer.

15. The user device of claim 11, wherein:
the zero-knowledge engine comprises a plurality of zero-knowledge circuits, and
each zero-knowledge circuit among the plurality of zero-knowledge circuits is configured to perform a particular step in a computation associated with processing the private data and the public data to verify an identity of the user.

16. The user device of claim 15, wherein:
a first zero-knowledge circuit among the plurality of zero-knowledge circuits is configured to perform a calculation involving the private data as part of processing the private data and the public data to verify an identity of the user, and
a second zero-knowledge circuit among the plurality of zero-knowledge circuits is configured to perform a calculation involving the public data as part of processing the private data and the public data to verify an identity of the user.

17. The user device of claim 16, wherein:
the first zero-knowledge circuit among the plurality of zero-knowledge circuits is configured to execute a first hash function, the first hash function having as inputs a result of a compound computation involving private inputs and a first salt, and
the second zero-knowledge circuit among the plurality of zero-knowledge circuits is configured to execute a second hash function, the second hash function having as inputs a result of a compound computation involving public inputs and a second salt.

18. The user device of claim 11, wherein the private data includes data selected from a list consisting of: information contained in a Machine Readable Zone of an identification document, information contained in a Document Security Object of the identification document, an LDSSecurityObject, and a SignedAttributes object associated with the identification document.

19. The user device of claim 11, wherein the identifying information associated with the user is from a government issued identification document.

20. A tangible, non-transitory, computer-readable medium storing program instructions that cause a device to execute a process comprising:
receiving identifying information associated with a user of a user device;
separating the identifying information into one or more subsets of information, wherein at least one subset of the identifying information includes a minimum quantity of data to verify the identifying information;
labeling the at least one subset of the identifying information that includes the minimum quantity of data to verify the identifying information as private data and a different subset of the identifying information as public data;
providing the private data and the public data to a zero-knowledge engine; and
processing, by the zero-knowledge engine, the private data and the public data to verify an identity of the user without exposing at least the private data to an entity other than the user.
